(19) United States
(12) Patent Application Publication
(10) Pub. No.: US 2012/0158635 A1
(43) Pub. Date: Jun. 21, 2012

(54) STORAGE EFFICIENT PROGRAMMABLE STATE MACHINE

(75) Inventor: Jan Van Lunteren, Gattikon (CH)

(73) Assignee: INTERNATIONAL BUSINESS MACHINES CORPORATION, Armonk, NY (US)

(21) Appl. No.: 12/970,127

(22) Filed: Dec. 16, 2010

(51) Int. Cl. G06N 5/02

(52) U.S. Cl. 706/48; 706/47

(57) ABSTRACT

A state machine includes a rule selector. The rule selector receives input data, and one or more transition rules. The one or more transition rules including a next state. The state machine also includes a character classifier communicatively coupled to the rule selector. The character classifier includes a plurality of base classes. The character classifier receiving the input data, and sending one or more of the plurality of base classes to the rule selector in response to receiving the input data. The rule selector selects one of the one or more transition rules in response to determining that the input data and one of the plurality of base classes correspond to the transition rule. The current state of the state machine is then set to the next state of the selected one of the one or more transition rules.

### BACKGROUND

The present invention relates generally to programmable state machines and more specifically to storage efficient programmable state machines.

Pattern matching of groups of characters are important aspects of many systems. Pattern matching methods such as regular expressions (regex) allow for efficient matching of patterns in text by classifying larger groups of characters using one or more pattern characters. The pattern characters are used as a shorthand for an entire group of characters. There are a number of uses for pattern matching including file searching, log parsing and a number of other applications where efficient searching through data is needed. One such use of pattern matching is for purposes of intrusion detection within a networked environment. In a networked environment packets of information, or groups of packets of information, are searched for patterns indicative of unauthorized and/or malicious access to the network. The volume of data transferred over a network necessitates faster speeds than are typically possible using a software based regex engine. In these instances special purpose built hardware accelerators are beneficial.

### SUMMARY

An embodiment includes a state machine including a rule selector. The rule selector receives input data, and one or more transition rules. The one or more transition rules including a next state. The state machine also includes a character classifier communicatively coupled to the rule selector. The character classifier includes a plurality of base classes. The character classifier receiving the input data, and sending one or more of the plurality of base classes to the rule selector in response to receiving the input data. The rule selector selects one of the one or more transition rules in response to determining that the input data and one of the plurality of base classes correspond to the transition rule. The current state of the state machine is then set to the next state of the selected one of the one or more transition rules.

Another embodiment is a system for mapping a set of base classes to an input pattern in a storage efficient programmable state machine. The mapping uses a pattern compiler module, the pattern compiler module compiles a deterministic finite automaton (DFA). The compiling includes receiving a plurality of base class vectors and a plurality of negated base class vectors. Receiving one or more unmapped transition rules in an unmapped list and processing each of the one or more unmapped transition rules. The processing includes selecting and removing one unmapped transition rule from the unmapped list, creating an input vector from the selected transition rule, generating one or more mapped rules from the input vector, and storing the one or more mapped rules in a mapped list.

Yet another embodiment is a method for mapping a set of base classes to an input pattern in a storage efficient programmable state machine. The method includes receiving a plurality of base class vectors and a plurality of negated base class vectors. Receiving one or more unmapped transition rules in an unmapped list and processing each of the one or more unmapped transition rules. The processing includes selecting and removing one unmapped transition rule from the unmapped list, creating an input vector from the selected transition rule, generating one or more mapped rules from the input vector, and storing the one or more mapped rules in a mapped list.

Additional features and advantages are realized through the techniques of the present embodiment. Other embodiments and aspects are described herein and are considered a part of the claimed invention. For a better understanding of the invention with the advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1A illustrates a block diagram of a system for storage efficient programmable state machines in an embodiment;

FIG. 1B illustrates a block diagram of a system for implementing storage efficient programmable state machines in an additional embodiment;

FIG. 2 illustrates a block diagram of a storage efficient programmable state machine in accordance with an embodiment;

FIG. 3 illustrates a block diagram of a rule vector in an embodiment;

FIG. 4 illustrates a block diagram of a class testing function within rule selector logic in an embodiment;

FIG. 5 illustrates a deterministic finite automaton (DFA) diagram depicting state transitions for matching of two patterns using transition rules according to an embodiment;

FIGS. 6A-6B illustrate a process flow for transition rule selection according to an embodiment;

FIGS. 7A-7B illustrate the states of a to-be-mapped list and a mapped list during the transition rule selection process according to an embodiment; and

FIG. 8 illustrates a DFA diagram depicting state transitions for matching of two patterns using transition rules according to an embodiment.

### DETAILED DESCRIPTION

A high performance pattern matching system is needed in systems that depend on quick processing of pattern matching to operate securely and effectively. The pattern matching scheme is based on programmable state machines, denoted as B-FSMs. In this system, so called transition rules are used to describe all possible transitions between the states in a given state transition diagram that is implemented by the engines.

One of the methods used to meet the high performance pattern matching requirements (e.g., tens of gigabits per second) is by improving the storage-efficiency of the pattern matching algorithms and their implementations to obtain a very compact data structure that allows to fit larger parts of the data structure into fast dedicated static random access memory (SRAMs) attached to the B-FSMs. Consequently, this allows a larger portion of all memory accesses to be served by the SRAMs. The remaining accesses (i.e., matches that are not contained in SRAM) are served using the often substantially slower memory (e.g., dynamic random access memory (DRAM)) at the next level in the memory hierarchy. One of the methods used to improve the storage-efficiency of the data structure at the hardware level, is the use of a classifier table. The classifier table allows transition rules to be defined that apply to character classes, which are sets of input values, e.g., a digit. By using classifier tables containing character classes, a single transition rule, or, in some cases a few rules, may be used instead of one rule for each input value contained in the character class. For example one transition can be used to branch from one state to another if the input is a digit (0, 1, 2 . . . or 9) instead of using ten transitions, one transition if the input equals 0, one transition if the input equals 1, and so on, for the case that character classes are not supported at the hardware level.

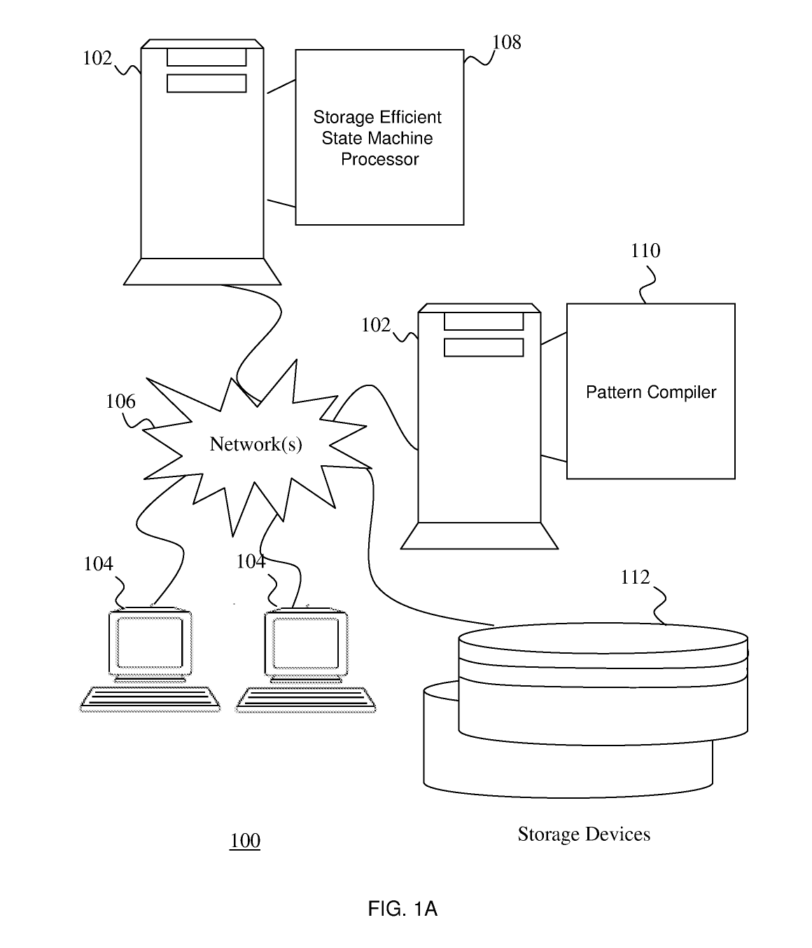

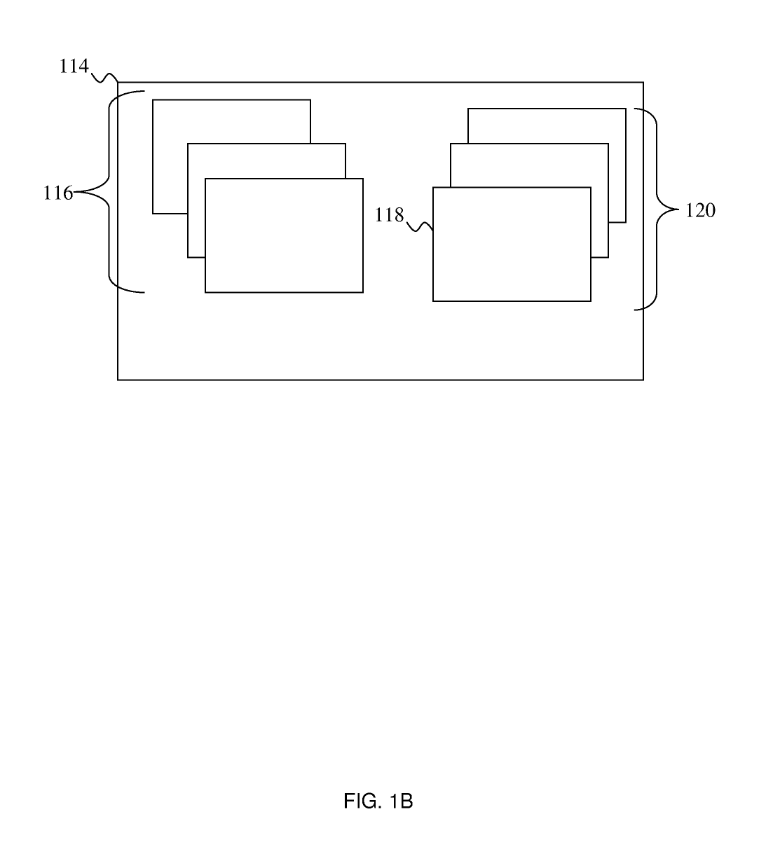

Turning now to FIG. 1A, a system 100 for implementing storage efficient programmable state machines will now be described. In an embodiment, the system 100 includes one or more host system computers 102 executing computer instructions for storage efficient programmable state machines. The one or more host system computers 102 may operate in any type of environment that is capable of executing a software application. One or more host system computers 102 may comprise a high-speed computer processing device, such as a mainframe computer, to manage the volume of operations governed by an entity for which the a storage efficient programmable state machine 108 process is executing. In an embodiment, the one or more host system computers 102 is part of an enterprise (e.g., a commercial business) that implements the storage efficient programmable state machine 108.

The one or more host system computers 102 additionally executes a pattern compiler for compiling state machine patterns as will be described in more detail below. FIG. 1A depicts the pattern compiler 110 and the storage efficient programmable state machine 108 as executing on two host system computers 102 in an embodiment. In an additional embodiment, the pattern compiler 110 and the storage efficient programmable state machine 108 are executed on a single host system computer.

In an embodiment, the system 100 depicted in FIG. 1A includes one or more client systems 104 through which users at one or more geographic locations may contact the one or more host system computers 102. The client systems 104 are coupled to the one or more host system computers 102 via one or more networks 106. Each of the client systems 104 may be implemented using a general-purpose computer executing a computer program for carrying out the processes described herein. The client systems 104 may be personal computers (e.g., a lap top, a personal digital assistant, a mobile device) or host attached terminals. If the client systems 104 are personal computers, the processing described herein may be shared by one of the client systems 104 and the one or more host system computers 102 (e.g., by providing an applet to the client systems 104). Client systems 104 may be operated by authorized users (e.g., programmers) of the storage efficient programmable state machines and the pattern compilers described herein.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. The client systems 104 may be coupled to the one or more host system computers 102 through multiple networks (e.g., intranet and Internet) so that not all client systems 104 are coupled to the one or more host system computers 102 through the same network. One or more of the client systems 104 and the one or more host system computers 102 may be connected to the networks 106 in a wireless fashion. In one embodiment, the networks 106 include an intranet and one or more client systems 104 executing a user interface application (e.g., a web browser) to contact the one or more host system computers 102 through the networks 106. In another embodiment, the client systems 104 are connected directly (i.e., not through the networks 106) to the one or more host system computers 102 and the one or more host system computers 102 contains memory for storing data in support of the storage efficient programmable state machine 108 and the pattern compiler 110. Alternatively, a separate storage device (e.g., storage device 112) may be implemented for this purpose.

In an embodiment, the storage device 112 includes a data repository with data relating to the storage efficient programmable state machine 108 and pattern compiler 110 by the system 100, as well as other data/information desired by the entity representing the one or more host system computers 102 of FIG. 1A. The storage device 112 is logically addressable as a consolidated data source across a distributed environment that includes networks 106. Information stored in the storage device 112 may be retrieved and manipulated via the one or more host system computers 102 and/or the client systems 104. In an embodiment, the storage device 112 includes one or more databases containing, e.g., storage efficient programmable state machines data, pattern compilers, and corresponding configuration parameters, values, methods, and properties, as well as other related information as will be discussed more fully below. It will be understood by those of ordinary skill in the art that the storage device 112 may also comprise other structures, such as an XML file on the file system or distributed over a network (e.g., one of networks 106), or from a data stream from another server located on a network 106. In addition, all or a portion of the storage device 112 may alternatively be located on one of the client systems 104.

The one or more host system computers 102 depicted in the system of FIG. 1A may be implemented using one or more servers operating in response to a computer program stored in a storage medium accessible by the server. The one or more host system computers 102 may operate as a network server (e.g., a web server) to communicate with the client systems 104. The one or more host system computers 102 handle sending and receiving information to and from the client systems 104 and can perform associated tasks. The one or more host system computers 102 may also include a firewall to prevent unauthorized access to the one or more host system computers 102 and enforce any limitations on authorized access. For instance, an administrator may have access to the entire system and have authority to modify portions of the system. A firewall may be implemented using conventional hardware and/or software as is known in the art.

The one or more host system computers 102 may also operate as an application server. The one or more host system computers 102 executes one or more computer programs to the provide storage efficient programmable state machine 108 and the pattern compiler 110. As indicated above, processing may be shared by the client systems 104 and the one or more host system computers 102 by providing an application (e.g., java applet) to the client systems 104. Alternatively, the client systems 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

In an additional embodiment the system 100 for implementing storage efficient programmable state machines is incorporated in a single package such as a computer chip 114 of FIG. 1B. The computer chip 114 includes one or more computer processors 116 for processing instructions. In an embodiment, the computer chip includes one or more accelerator circuits 120. In an embodiment the one or more accelerator circuits 120 are configured to process instructions and/or data efficiently with specialized circuitry capable of high-speed processing. In an embodiment, at least one of the accelerator circuit 120 is a programmable state machine such as a storage efficient programmable state machine 118 of FIG. 1B. In an embodiment, the computer processors 116 are communicatively coupled to the accelerator circuit 120. In an additional embodiment, the accelerator circuit 120 also process instructions and data directly, bypassing the one or more computer processors 116. In an embodiment, at least one of the accelerator circuit 120 is a programmable a pattern compiler.

It will be understood that the execution of the storage efficient programmable state machines as well as the pattern compiler module processes and methods described in FIGS. 1A and 1B may be implemented as modules in hardware, software, or a combination thereof.

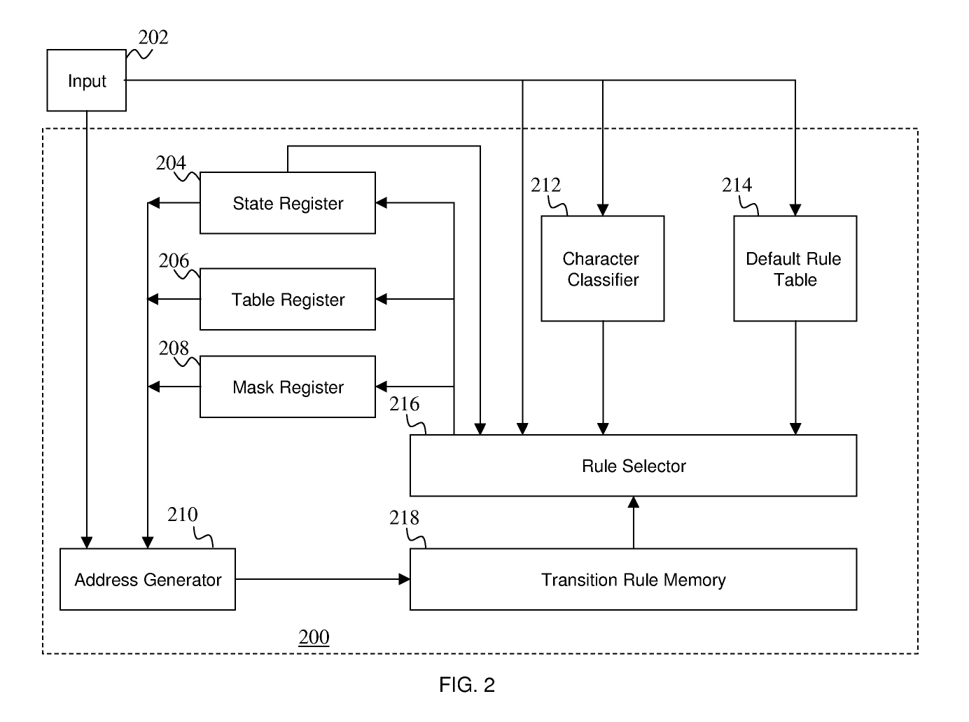

FIG. 2 illustrates a block diagram of a storage efficient programmable state machine 200 (also referred to herein as “pattern-matching accelerator”) in accordance with an embodiment. In one embodiment the pattern-matching accelerator 200 is executed on the one or more host system computers 102 of FIG. 1A. In an additional embodiment, the pattern-matching accelerator 200 is executed in the storage efficient programmable state machine 118 of FIG. 1B.

In an embodiment, input 202 is received at an address generator 210, a rule selector 216, a character classifier 212, and a default rule table 214. In an embodiment the input 202 is one or more characters of data. In another embodiment, the input is any set of bits used to represent data as is known in the art. The address generator 210 receives the input 202 and data from one or more of a state register 204, a table register 206, and a mask register 208. The input is received one symbol (i.e., a character or set of bits) at a time and is processed by the pattern-matching accelerator 200 by transitioning from state to state. In one embodiment the state transitions continue until all of the input 202 has been processed. In an additional embodiment, the input 202 is processed until one or more specific patterns have been matched. In one embodiment the address generator 210 uses the received data to generate a hash value using a hash function. The hash is passed to a transition rule memory 218. The transition rule memory 218 comprises one or more rule vectors. In an embodiment the one or more rule vectors are stored in a compact hash table and are accessible by a hash value, such as the hash value received from the address generator 210.

In one embodiment, when the transition rule memory 218 receives a hash value from the address generator 210, the transition rule memory 218 passes any rule vectors that are stored in the hash table relative to the hash value received from the address generator 210 to a rule selector 216. The rule selector 216 uses input 202, data from one or more of the state register 204, the character classifier 212, and the default rule table 214. In an embodiment, the rule selector 216 receives one or more input class vectors from the character classifier 212. In an embodiment the one or more input class vectors are bit masks indicating the base class or base classes, if any, that match the input symbol that is received at the character classifier 212 from the input 202. In one embodiment, each input class vector is an 8 bit vector that can represent 256 base classes. In additional embodiments the input class vector may be any length longer or shorter than 8 bits. The rule selector 216 uses the one or more input class vectors received from the character classifier 212 to determine which of the rules received from the transition rule memory 218 apply to the input symbol. The rule selector 216 also receives the current state of the pattern-matching accelerator 200 from the state register 204. The state register 204 stores the current state of the pattern-matching accelerator 200 and receives the new state of the pattern-matching accelerator 200 whenever the state changes. In addition, the rule selector 216 receives the current input symbol from the input 202. The rule selector 216 receives one or more default rule vectors from the default rule table 214. The default rule table 214 selects one or more rules vectors associated with the input symbol received from the input 202. After receiving the input 202, the rule selector 216 selects a rule vector from the transition rule memory 218 based on the input symbol, the current state, and the input class. If no rule vector is selected, the rule selector 216 selects one of the default rules received from the default rule table 214. In one embodiment, the rule selector 216 processes 2 or more rule vectors in parallel.

The rule vector includes a test part with values that the rule selector 216 uses to determine if the rule matches the input symbol based on the current state of the pattern-matching accelerator 200 as will be described in more detail below. Once a matching rule vector is found, the rule selector 216 accesses the result part of the rule vector and uses the values stored there to set the next state in state register 204, set the address in the transition rule memory 218 where the next state can be found for the current state in the table register 206, and set a mask in the mask register 208. If no rule vector from the transition rule memory 218 matches the input symbol, then the rule selector 216 selects values from the default rule vector received from the default rule table 214.

The illustration of FIG. 2 is a simplified representation of the various components of the pattern-matching accelerator 200 for purposes of clarity. It will be understood by those of ordinary skill in the art that the additional or fewer components may be used in alternate embodiments. In additional embodiments, the layout and configuration of the components may differ from those of FIG. 2 without affecting the functionality of the pattern-matching accelerator 200. In additional embodiment, the various components may be located in separate modules. In further embodiments, the functionality of various components may be incorporated into a single hardware or software module.

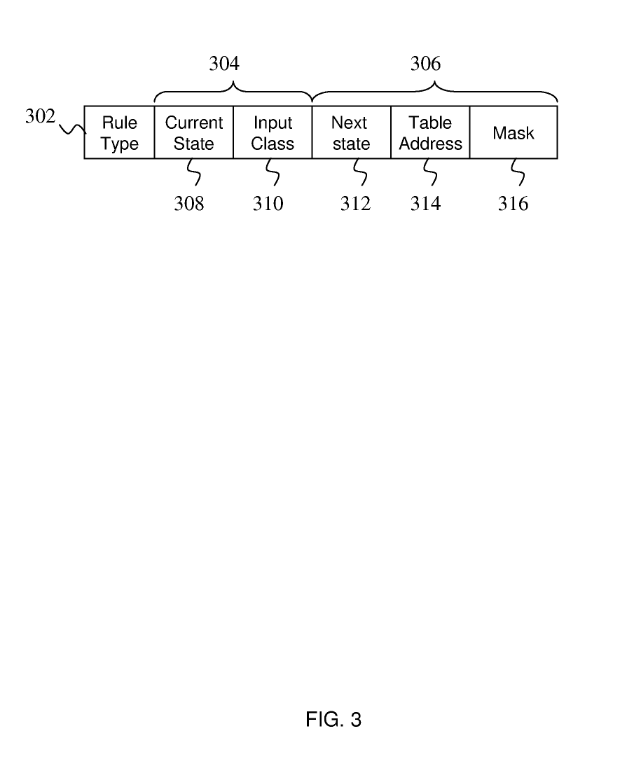

FIG. 3 illustrates a block diagram of a rule vector in an embodiment. The rule vector includes a rule type 302. The rule type 302 indicates which of the one or more input class vectors received from the character classifier 212 to test against an input class value 310 of the rule vector. In additional embodiments, if a rule vector involves a class condition related to the input (i.e., the rule includes a specific value that is outside of a class, or excludes a character in a class), then the rule type 302 will contain information to reflect this state.

The rule vector includes a test part 304, which includes a current state value 308 and the input class value 310. In an embodiment, the current state value 308 indicates the state that the pattern-matching accelerator 200 must be in for the rule vector to apply. The input class value 310 indicates the character class rules to apply to the rule vector. The input class value 310 is used in a bit-wise operation against the input class vectors received from the character classifier 212 of FIG. 2 to indicate if the rule vector's next state transition should be applied as will be described in more detail below. In an embodiment, the rule vector additionally includes a result part 306. The result part 306 contains values that indicate actions or values that must be set as a result of the selection of the rule vector. The result part 306 includes a next state value 312. The next state value 312 indicates the state transition that the pattern-matching accelerator 200 will perform as a result of the current symbol received from the input 202 of FIG. 2. The state register 204 is set to the next state value 312 as result of the rule vector selection. The result part 306 additionally includes the table address value 314. The table address value 314 indicates the address in the transition rule memory 218 of FIG. 2 where transition rules for the next state are located. The address generator 210 uses the table address value 314 to generate a hash value as described above. The table register 206 is set to the table address value 314 if the rule vector is selected as a match. The result part 306 additionally includes a mask value 316. The mask value 316 defines the hash function that the address generator 210 will use when generating a hash value as described above. The mask register 208 is set to the mask value 316 as if the rule vector is selected.

The input class value 310 of each rule vector indicates the base classes that match the rule vector. In one embodiment this is done using a bit wise AND operation of the input class value 310 against the input class vectors that match the rule type field. If the result is not zero, then that means that the input value is part of at least one of the base classes that were specified in the input/class field and which correspond to the selected class vector. In this case, the input/class condition evaluates positively, and if the current state value 308 matches the pattern-matching accelerator's 200 current state the rule is selected. If, however, the bit wise AND result evaluates to zero, or the current state of the pattern-matching accelerator 200 does not match the current state value 308 of the rule vector, then the rule will not be selected, and the rule selector 216 will evaluate the next rule vector received from the transition rule memory 218.

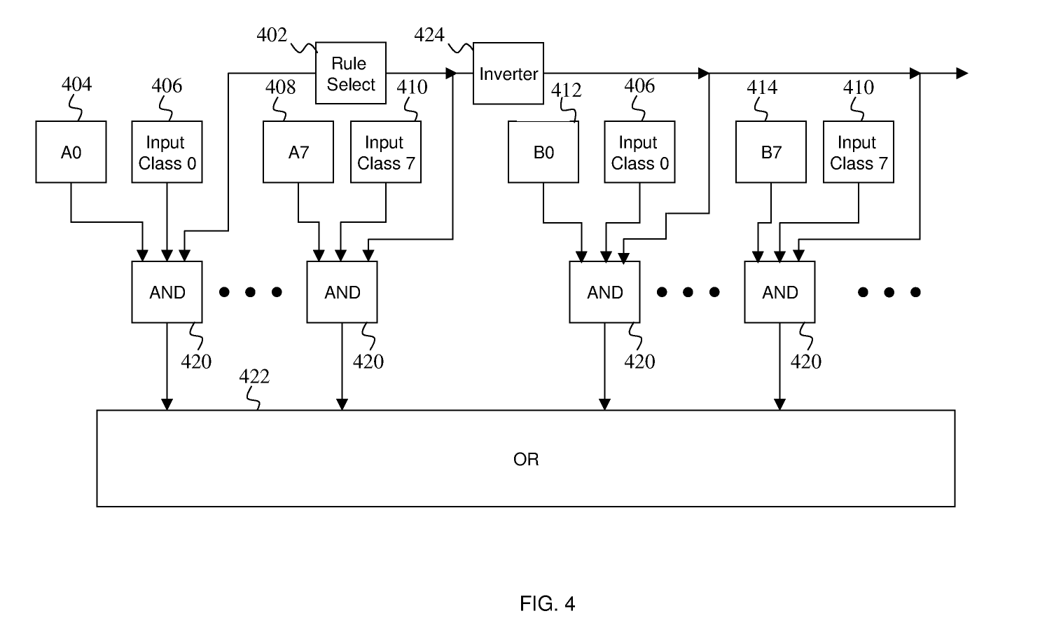

FIG. 4 illustrates a block diagram of rule selector logic in an embodiment. In an embodiment, the circuits of FIG. 4 are implemented by the rule selector 216. A plurality of 3-input AND gates 420 receive input values in parallel. In one embodiment the input class value 310 of FIG. 3 is compared to 2 input class vectors A and B received from the character classifier 212. The first AND gate receives the first bit of the input class vector A 404, the first bit of the input class vector 406, and the rule selection bit 402 of the rule type 302, which indicates if input class vector A or input class vector B should be applied. Each of the bits of the input class vector A (in this example 8) are applied to the AND gates 420. At the same time, the rule select bit 402 is inverted by an inverter 424 and the first bit of the input class vector B 412, the first input class value bit 406 of the input class value 310 and the inverted value of the rule selection bit received from the inverter 424 of the rule type 302, are applied to other 3 input AND gates 420. Each of the bits of the input class vector B (in this example 8) are applied to the AND gates 420. The output of the AND gates 420 is sent to an OR gate 422. If the OR gate 422 evaluates to 1 (i.e., one or more of the AND gates 420 evaluate to 1) then the current input 202 matches the class condition specified by the rule selection bit 402 of the rule type 302 and the input class value 310 and, as a result, the pattern-matching accelerator 200's state is set to the next state value 312 by updating the state register 204 to the next state value 312, the table register 206, and the mask register 208 are updated as described above with regard to FIG. 2. If however, the OR gate 422 evaluates to 0 (i.e., none of the AND gates evaluate to 1) then the next rule vector received from the transition rule memory 218 is evaluated using the same mechanism. If, after evaluating all of the rule vectors, none of the rule vectors evaluate to 1, then a default rule is selected from the default rules received from the default rule table 214, and the state register 204, the table register 206, and the mask register 208 set according to the values in the selected default rule.

The selector logic of FIG. 4 applies only 2 8-bit input class vectors, however, it will be understood by those of ordinary skill in the art that additional input class vectors of any number of bits may be used in additional embodiments.

As stated above, each of the bits of the input class vector represents a base class. The base classes represent one or more symbols. Table 1A depicts a subset of three base classes in an embodiment. It will be understood that the base classes of Table 1A are for purposes of clarity only and that any number or combination of base class configurations may be used in additional embodiments.

TABLE 1A

| | | |
|---|---|---|
| Base Class 1: | digit | [0-9] |
| Base Class 2: | lower-case alphabet | [a-z] |
| Base Class 3: | upper-case alphabet | [A-Z] |

These three base-classes can be combined in eight different ways (2 to the power of 3), resulting in the base class combinations listed in Table 1B, that can directly be tested using the class conditions specified in a given rule as described above.

TABLE 1B

| | | |
|---|---|---|
| Base Class Combination 1: | empty | [ ] |
| Base Class Combination 2: | digit | [0-9] |
| Base Class Combination 3: | lower-case alphabet | [a-z] |
| Base Class Combination 4: | upper-case alphabet | [A-Z] |
| Base Class Combination 5: | digit and lower-case alphabet | [0-9a-z] |
| Base Class Combination 6: | digit and upper-case alphabet | [0-9A-Z] |
| Base Class Combination 7: | lower and upper case alphabet | [a-zA-Z] |
| Base Class Combination 8: | alphanumeric (digit/lower/ | [0-9a-zA-Z] |
| | uppercase alphabet) | |

The base class combinations, for example as listed in Table 1B, illustrate the character classes that can directly be tested by the class conditions in the transition rules as described above. However, the states and transition rules that can be generated for pattern matching typically contain arbitrary character classes that can be equal to a given base class or combination of base classes, but often that will not be the case. For those situations, a base class mapping function is applied that maps the rules of a given state, which involve arbitrary character classes upon a new set of rules that can be tested directly using the rule selection process described above. The efficiency of performing this base class mapping directly affects the storage efficiency of the resulting data structure and consequently affects the system's performance because it directly impacts the processing throughput through its influence on the cache performance. In an embodiment, the base class mapping function finds a mapping using as few rules as possible. In one embodiment, these arbitrary classes originate from a pattern matching function involving regular expressions such as ab[0-8]c and ab[Aa-z]d. In these cases a string will match the first regular expression of the string consists of the symbols ab followed by any number between 0 and 8 inclusive and ends in c. The second regular expression matches all strings that start with the symbols ab but include any of the lower case characters a-z and capital ‘A’ and end in d.

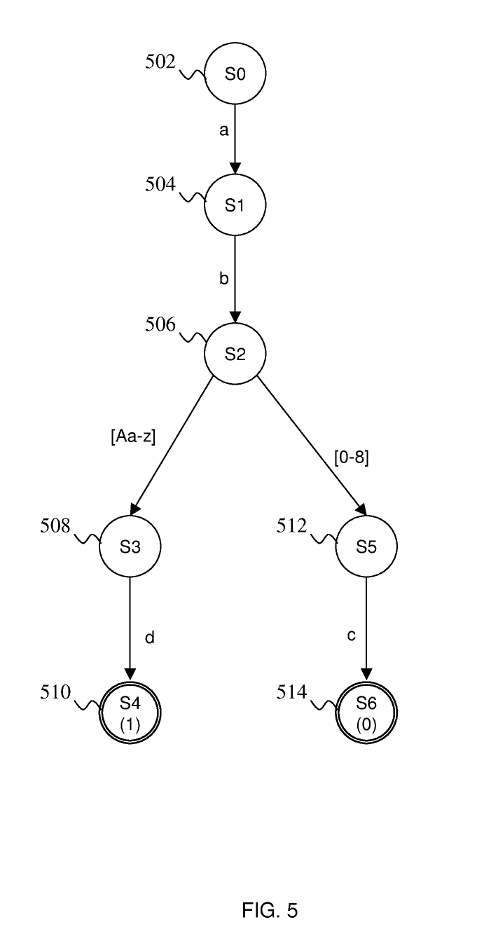

FIG. 5 illustrates a deterministic finite automaton (DFA) diagram depicting state transitions for matching of the two regular expressions ab[0-8]c and ab[Aa-z]d according to an embodiment. The match starts at state 0 502, and if the input symbol is an ‘a’ then the state changes to state 1 504. At state 1 504 if the next input symbol is a ‘b’ the state changes to state 2 506. At state 2 506 if the next input symbol is any of ‘A’ or ‘a’-‘z’ then the state changes to state 3 508. At state 3 508, if the next input symbol is a ‘d’ the state is changed to state 4 510, and a match is confirmed for the regular expression ab[Aa-z]d. Returning to state 2 506, if the next input symbol is ‘0’-‘8’ then the state will change to state 5 512. At state 5 512, if the next input symbol is a “c”, then the state changes to state 6 514, and a match is confirmed for the regular expression ab[0-8]c.

In the embodiment illustrated in FIG. 5, a base class set is used that includes the class digit [0-9] as base class 1 of Table 1A and lower-case alphabet [a-z] as base class 2 of Table 1A. As stated above with regard to FIG. 5, the transition from state 2 to state 3 covers input values that are contained in base class 2 of Table 1A (i.e., [a-z]) plus one additional character A. The other transition from state 2 to state 5 covers input values that are contained in base class 1 of Table 1A with the exception of one character ‘9’. The transitions between these states may be depicted as transition rules represented by rule R1 and rule R2 as depicted in Table 2.

TABLE 2

| | Current | Arbitrary | | |
|---|---|---|---|---|
| Rule | State | Class | Next State | Priority |
| R1 | S2 | [0-8] | S5 | 2 |
| R2 | S2 | [Aa-z] | S3 | 2 |

Table 2 depicts the two rules R1 and R2 for state 2, the arbitrary classes, and the next state for each of the rules if the input symbol matches the arbitrary classes. Table 2 also depicts a priority. In an embodiment, each rule is given a priority, and the rules are sorted so that the higher priority rules are selected first as will be described in more detail below.

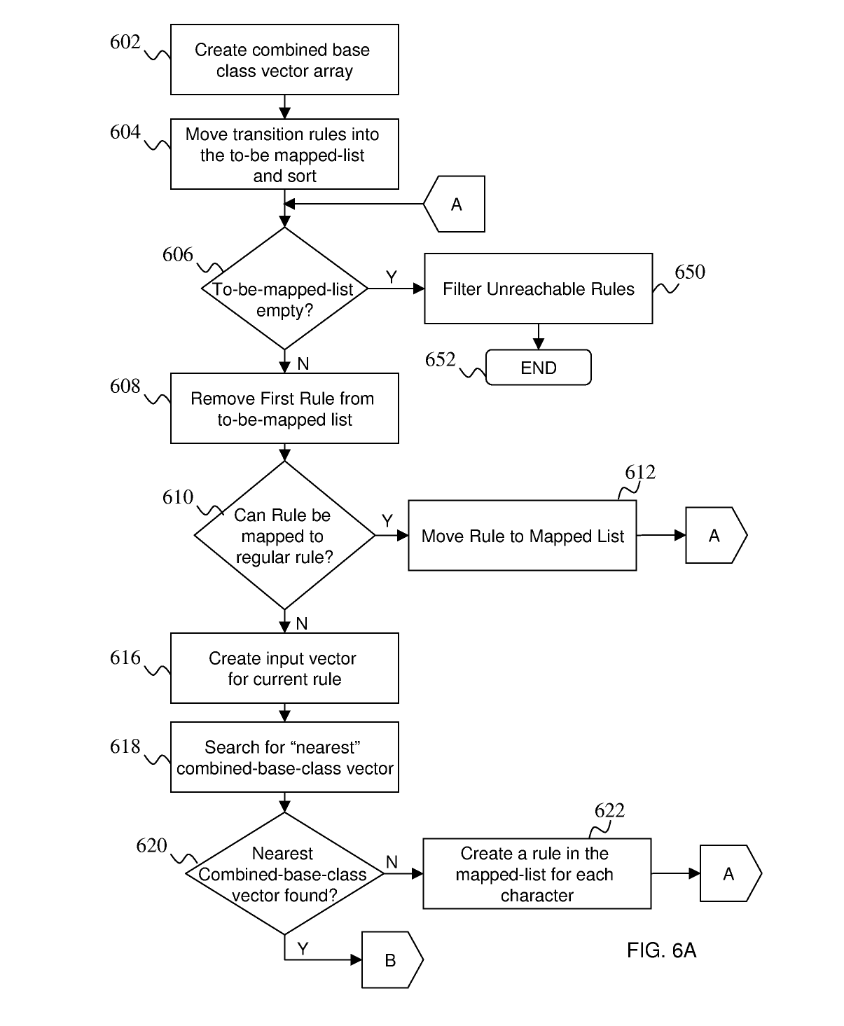

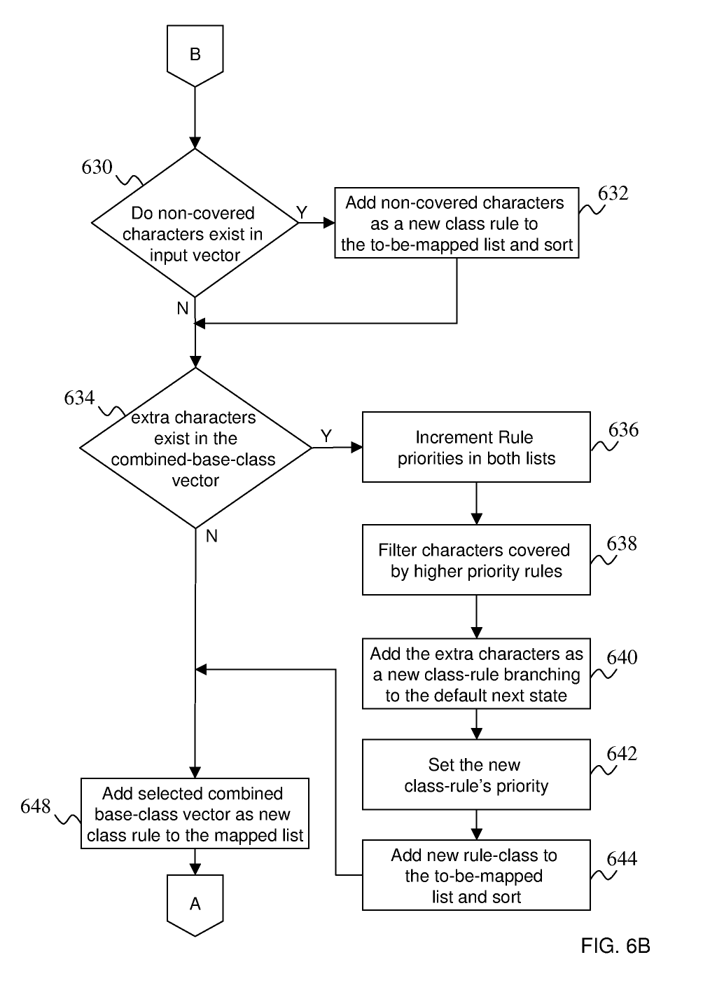

FIGS. 6A and 6B illustrate a process flow for transition rule selection in an embodiment. In an embodiment the base class mapping function is executed within a so called pattern compiler module, which converts the set of patterns to be matched into data structures that are downloaded into the memories of the hardware regex engine. In an embodiment, the pattern compiler module is pattern compiler 110 of FIG. 1A. In an alternate embodiment, the pattern compiler module is a hardware module. In yet another embodiment, the pattern compiler module is a combination of hardware and software components. In an embodiment, at block 602, an array with 512 rule vectors, each rule vector including a 256-bit vector is created. The first set of 256 rule vectors (i.e., half of them) contains a 256-bit vector for each possible combination of base classes. Each bit vector will have a set bit at a given position m, when the associated base class combination contains the character value (corresponding to) m. The second set of rule vectors includes 256 256-bit vectors that are the negated versions of the first set of 256 rule vectors, with each bit vector containing set bits at positions that are part of the negated base class combination (i.e., the bit vector contains a set bit at positions corresponding to character values that are not part of the associated base class combination). These bit vectors will be denoted herein as combined-base-class vectors.

At block 604 all transition rules of the current state are moved into a to-be-mapped-list and the to-be-mapped list is sorted according to a decreasing class size (i.e., rules with the largest character classes come first, and rules involving only a single character (exact match conditions) come last). At block 606 if the to-be-mapped list is not empty processing proceeds to block 608. At block 608, the first rule in the to-be-mapped list (i.e., the one with the largest class) is removed from the list and at block 610 it is determined if it can be mapped to a regular non-class rule. In one embodiment the regular rules are exact-match (e.g., =‘a’), case-insensitive match (e.g., =‘a’ or ‘A’), negated exact-match (e.g., does not equal ‘a’) or negated case-insensitive match conditions (e.g., does not equal ‘a’ and does not equal ‘A’). If the first rule can be mapped to a regular rule, then the first rule is moved to the mapped-list at block 612, and processing continues at block 606. Returning to block 610, if the first rule cannot be mapped to a regular rule, then processing continues to block 616. At block 616, a bit vector including 256 bits (referred to as the current input vector) is created with bits set corresponding to the input values covered by the rule being processed. In one embodiment, each bit in the bit vector corresponds to a character in an ASCII table as is known in the art, where, for example, bit 97 corresponds to an ‘a’, bit 65 corresponds to an ‘A’ etc. In an embodiment, the first rule corresponds to [Aa-z] and the bits 65 and 97-122 are set to 1 and the remaining bits are set to 0. It will be understood that the ASCII character set is used for purposes of clarity and that in other embodiments, other character sets as are known in the art or bit position values may be selected.

At block 618 the current input vector is compared to the 512 combined base class vectors created at block 602 and the 256-bit vector that is closest to the current input vector is selected. In one embodiment, the vectors are compared using bitwise “and” logic and bitwise “and not” logic and the combined base class vector that results in the largest number of common bits and the lowest number of bits that are unique to each of the compared vectors is selected. In other embodiments, other methods of comparing the current input vector to each of the combined base class vectors, such as bit-by-bit compares, as is known in the art, may be used.

In one embodiment a value expressing how “near” two bit vectors are can be expressed as a function f(#common,#unique1,#unique2), in which #common represents the number of character values that the classes corresponding to the current input vector and one of the combined base class vectors have in common (i.e., the number of set bits in the bitwise AND product), and #unique1 and #unique2 represent the number of character values that are only part of the respective classes corresponding to the vectors in the current input vector and combined-base-class-vector combination (i.e., the number of set bits in the bitwise AND NOT products). An example of a function f(#common,#unique1,#unique2) is: f(#common,#unique1,#unique2)=#common−(#unique1+#unique2) if (#common>(#unique1+#unique2)) and f(#common,#unique1,#unique2)=0 if (#common<=(#unique1+#unique2)) This function can be used to find a combined-base-class-vector for which f( )results in the largest value in combination with the current input vector. That combined-base-class vector will then be the “nearest” one to the current input vector.

At block 620, if a match is not found (i.e., the results of all functions equals 0) then at block 612, a separate regular rule for each symbol in the first rule covered by the current input vector is added to the mapped-list at block 622 and processing continues at block 606. For example, if the current input vector is [a-c] and no matches are found at block 620, then a regular rule to match the symbols ‘a’, ‘b’, and ‘c’ is added in the mapped list. Returning to block 620, if a match is found, processing continues at block 630 of FIG. 6B. At block 630, if characters exist in the current input vector that are not in the matching combined base class vector, selected at block 620, (i.e., the combined base class vector does not have all of the characters in the current input vector) then at block 632 the non-covered characters in the current input vector are added as a single rule to the to-be-mapped list, and the list is sorted again by decreasing class size. For example, if characters a, d, and e were in the current input vector, then a new rule including the character class [ade] is added to the to-be-mapped list and the list is resorted. Returning to block 632, once the new rule is added to the to-be-mapped list processing continues at block 634. Returning to block 630, if all of the characters in the current input vector are in the matching combined base class vector, then processing continues at block 634.

At block 634, if the matching combined base class vector contains extra characters that do not exist in the current input vector, then processing continues at block 636. At block 636 the priority of all of the rules in both the mapped list and the to-be-mapped list are incremented for all rules that have a priority that is at least equal to the current input vector. At block 638, all the extra characters from the matching combined base class vector that are covered by higher-priority rules are filtered. At block 640 a single new rule is created involving a character class containing any remaining extra characters that were not filtered at block 638. At block 642 the new rule's priority is incremented by one. At block 644 the new rule is added to the to-be-mapped list referring to the default next state and the to-be-mapped list is sorted again by decreasing class size. The default next state in this case, would be the next state to which the state machine would branch when being in the state that is currently processed, if an input value occurs for which no transition rule has been defined. Returning to block 644, once the new rule is added to the to-be-mapped list and sorted, processing continues at block 646. At block 646 the matching combined base class vector is added to the mapped list as a new class rule keeping its current priority. Because the priority of the other rules was incremented at block 636, the current rule is placed at a priority level below other higher priority rules in the mapped list. Once the rule is added to the mapped list processing continues at block 606. Returning to block 634, if there are no extra characters in the matching combined base class vector, processing continues at block 646.

Returning to block 606 of FIG. 6A, if the to-be-mapped list is empty, processing continues at block 650. At block 650 any of the rules in the mapped list that are unreachable (i.e., they are entirely covered by higher priority rules) are filtered from the mapped list. Once the rules are filtered processing ends at block 652 and the new updated DFA will only contain transition rules involving character classes that can directly be tested by a base-class combination.

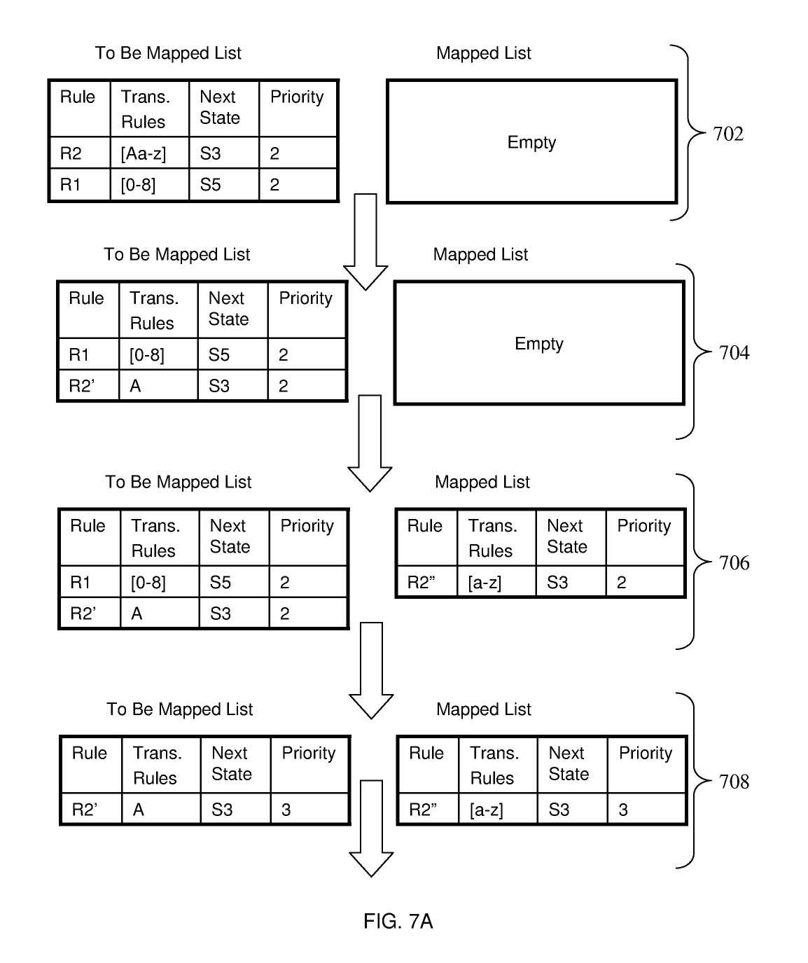

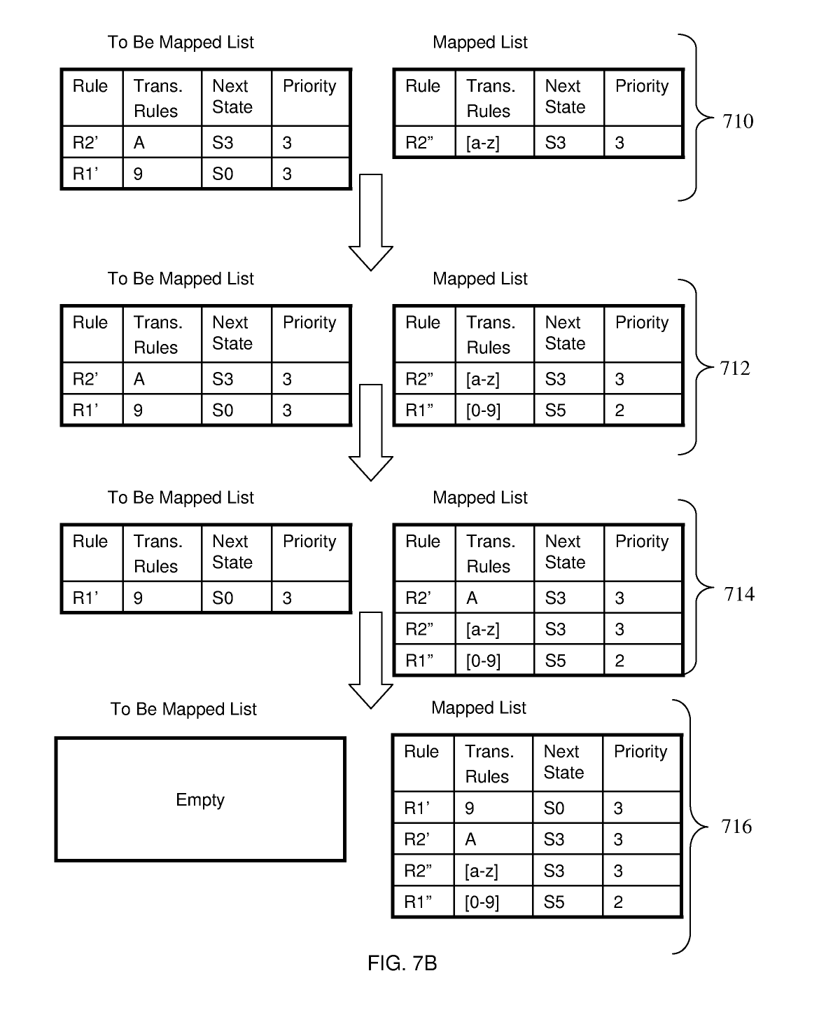

FIGS. 7A-7B illustrate the states of the to-be-mapped list and the mapped list for the rules of Table 2 above, throughout the process flow blocks of FIGS. 6A and 6B in an embodiment. FIGS. 7A-7B use a simplified rule set for purposes of clarity, but it will be understood by those of ordinary skill in the art that additional rules and data values may be applied in additional embodiments. For simplicity, only 8 of the 256-bit vectors will be used signifying all base class combinations [ ], [0-9], [a-z], [0-9a-z] and their inverses, for the set of two base classes [0-9] and [a-z]. Table 3 illustrates a hexadecimal representation of the 4 base class combinations and their inverses after the creation of the combined base class bit vector array of block 602 of FIG. 6A in an embodiment. In Table 3, the hexadecimal representation includes the bit at position 0 (corresponding to a character value 0) at the most-significant bit position.

TABLE 3

| Class | Base Class | |
|---|---|---|
| # | Combination | Bit Representation |
| 0 | empty | 0000 0000 0000 0000 0000 |
| | | 0000 0000 0000 0000 . . . 0000 |
| 1 | [0-9] | 0000 0000 0000 FFC0 0000 |
| | | 0000 0000 0000 0000 . . . 0000 |
| 2 | [a-z] | 0000 0000 0000 0000 0000 |
| | | 0000 7FFF FFE0 0000 . . . 0000 |
| 3 | [0-9a-z] | 0000 0000 0000 FFC0 0000 |
| | | 0000 7FFF FFE0 0000 . . . 0000 |
| 4 | Not empty | FFFF FFFF FFFF FFFF FFFF |
| | | FFFF FFFF FFFF FFFF . . . FFFF |
| 5 | [\hat{ }0-9] | FFFF FFFF FFFF 003F FFFF |
| | | FFFF FFFF FFFF FFFF . . . FFFF |
| 6 | [\hat{ }a-z] | FFFF FFFF FFFF FFFF FFFF |
| | | FFFF 8000 001F FFFF . . . FFFF |
| 7 | [\hat{ }0-9a-z] | FFFF FFFF FFFF 003F FFFF |
| | | FFFF 8000 001F FFFF . . . FFFF |

Returning to FIG. 7A, at state 702 the to-be-mapped list is filled with the rules R1 and R2 and are sorted so that the rule with the largest class size (i.e., R2) is at the top of the list. Although the to-be-mapped list at state 702 depicts only 2 rules for clarity, it will be understood that the loading and sorting steps apply equally to any number of rules. The mapped list at state 702 is empty. Rule 2 is selected at block 608 and processing continues through block 616 of FIG. 6 where an input vector is created from the current rule (i.e., R2). The arbitrary class of R2 (i.e., [Aa-z]) is converted to a hexadecimal representation of the input vector such as “0000 0000 0000 0000 4000 0000 7FFF FFE0 0000 . . . 0000,” in an embodiment. At block 618 of FIG. 6A the input vector is compared to each of the combined base class bit vectors illustrated in Table 3 in an embodiment. The nearest vector to the input vector is combined base class vector 2. Applying the function f(#common,#unique1+#unique2) to combined base class vector 2 results in f(26, 1, 0)=26−(1+0)=25. In contrast applying the function to combined base class vector 3 results in f(26−(1+10))=15. Returning to the process flow of FIG. 6B at block 632 the character not covered by the combined base class vector (i.e., ‘A’) is added to the to-be-mapped list as rule R2′ as illustrated at state 704 of FIG. 7A. Processing continues at block 646 of FIG. 6B where the selected combined base class vector (i.e., Class 2) is added to the mapped list as rule R2″ as depicted at state 706 of FIG. 7A. Processing then returns to block 608 of FIG. 6A where the next rule (i.e., R1) is removed from the to-be mapped list. Once again an input vector is created for the selected rule (i.e., R1) which is represented in hexadecimal as “0000 0000 0000 FF80 0000 0000 0000 0000 0000 . . . 0000,” in an embodiment. The input vector is compared to all of the combined base class vectors of Table 3 and the closest match is selected, in this case, base class combination 1. Processing continues to block 630 of FIG. 6B, and because there are no non-covered characters in the input vector (i.e., all of [0-8] are covered in the selected base rule) processing continues to block 634. At block 634 it is determined that an extra character exists in the selected base class combination that is not in the input vector (i.e., 9). At block 636 the priorities for all rules equal to or higher than the priority of the input vector (i.e., >=2) are increment, which is depicted in state 708 of FIG. 7A.

Returning to the process flow illustrated in FIG. 6B, at block 640 the extra character ‘9’ is created with a next state of state ‘S0.’ At block 642 the new rule is set to the current priority+1 (i.e., 3) and at block 644 the new rule is added to the to-be-mapped list as illustrated at state 710 of FIG. 7B. At block 646 the selected base class combination is added as a rule (i.e., R1″) to the mapped list at its priority (i.e., 2) as illustrated at state 712 of FIG. 7B. Processing then returns to block 606 of FIG. 6A.

At block 608 of FIG. 6A the next rule is selected and removed from the to-be-mapped list (i.e., R2′) and processing continues to block 610. Because R2′ represents a single symbol (i.e., ‘A’) it is mapped to a regular (non-base class rule) and is added to the mapped list at block 612 as rule R2′ as illustrated in state 714 of FIG. 7B and processing returns to block 606 of FIG. 6A.

At block 608 of FIG. 6A the next rule, and in this case the last rule, is selected and removed from the to-be-mapped list (i.e., R1′) and processing continues to block 610. Because R1′ represents a single symbol (i.e., ‘9’) it is mapped to a regular (non-base class rule) and is added to the mapped list at block 612 as rule R1′ as illustrated in state 716 of FIG. 7B and processing returns to block 606 of FIG. 6A.

At block 606 of FIG. 6A, the to-be-mapped list is empty and processing continues at block 650. At block 650, because no rules are unreachable, (i.e., no lower priority rules are covered by higher priority rules) the mapped list is not further filtered and processing ends at block 652. The rules in the mapped list in state 716 of FIG. 7B are then stored in the transition rule memory 218 using a hash function as described above.

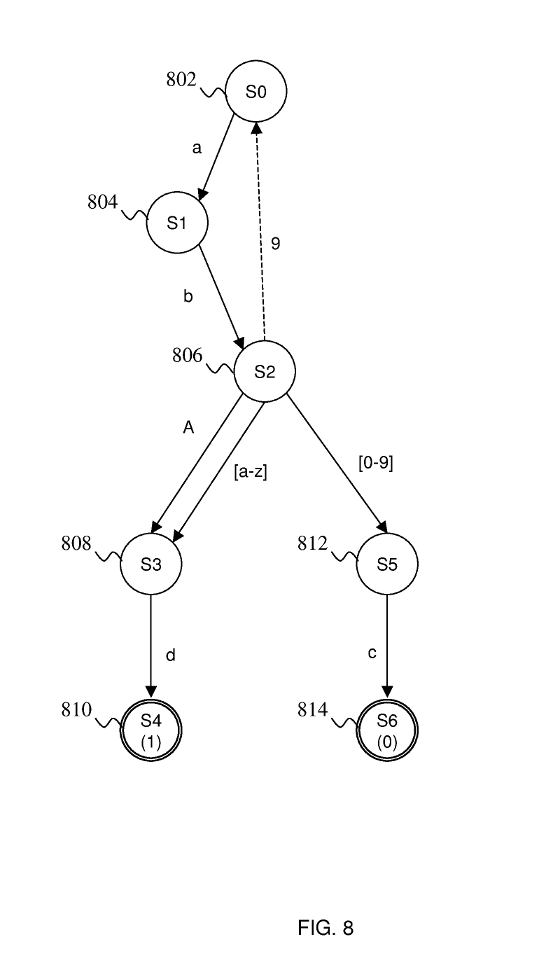

FIG. 8 illustrates a DFA diagram depicting state transitions for matching of the two regular expressions ab[0-8]c and ab[Aa-z]d as a result of the base class mapping described in FIGS. 7A-7B above in an embodiment. The match starts at state 0 802, and if the input symbol is an ‘a’ then the state changes to state 1 804. At state 1 804 if the next input symbol is a ‘b’ the state changes to state 2 806. At state 2 806 if the next input symbol is an ‘A’ then rule R2′ is used and according to the next state of the transition for rule R2′ the state changes to state 3 808. Returning to state 2 806, if the next symbol is any of a-z then the rule R2″ is used and, according to the next state of the transition for rule R2″ the state changes to state 3 808. At state 3 808, if the next input symbol is a ‘d’ the state is changed to state 4 810, and a match is confirmed for the regular expression ab[Aa-z]d. Returning to state 2 806, if the next input symbol is a 9 then, although both rule R1′ (i.e., the symbol ‘9’) and R1” (i.e., all of the symbols 0-9 including ‘9’) match the input symbol, rule R1′ is selected because it has a higher priority (i.e., priority of 3) than the rule R1″ (i.e., priority of 2)—this is represented by the dotted arrow in FIG.8 corresponding to rule R1′. The next state transition of rule R1′ is state 0 802. Returning to state 0 802 starts the state matching over again because, in this instance, a 9 is not a valid input for the state 2 806. Returning to state 2 806, if the input symbol is ‘0’-‘8’ then the state will change to state 5 812. At state 5 812, if the next input symbol is a ‘c’, then the state changes to state 6 814, and a match is confirmed for the regular expression ab[0-8]c.

The specific characters, base classes, and rules depicted in above are used for illustrative purposes only and are not meant to be limiting. It will be understood by those of ordinary skill in the art that any characters or combination of characters may be used in other embodiments.

The base classes describe above are a subset of a larger group of base classes and is used for clarity. In an embodiment, the total number of possible base classes is larger than can fit entirely in a system's SRAM and therefore a number of base classes will be stored in other, slower memory. In order to efficiently process pattern matching, a number of methods are proposed for selecting the base classes that are stored in the SRAM.

The base classes are selected in order to minimize the size of the B-FSM data structures that are obtained by mapping/compiling the given DFAs. In an embodiment, the base class mapper maps class rules involving arbitrary character classes on a minimum set of rules involving base class combinations such as described above.

In an embodiment, the base classes are selected by analyzing the arbitrary classes that are contained in the patterns that are involved in the pattern matching operation. In another embodiment, only a subset of those patterns are analyzed. In an additional embodiment, base classes are selected based on statistical information on classes that are most frequently used in regular expressions (e.g., digit, hex digit, white space, etc.).

In another embodiment, the patterns involved in the patter matching are first compiled into DFAs by the pattern compiler, and the above analysis is performed on the character classes and transition rules that occur inside the generated DFAs. This provides a more detailed insight in the kind of arbitrary character classes that can occur due to various sorts of pattern overlaps.

In an embodiment, the character classes analysis results are listed as a distribution such as the number of times the base class was encountered during the analysis. Based on the given classifier configuration, e.g., number of base class sets (e.g., set A and B) and size of each set (e.g., 8 base classes described using an 8-bit class vector), the base classes are selected by determining the most frequently occurring common subclasses in the list. In an additional embodiment, the distribution is weighted by the size. In further embodiments, the distribution may be weighted by other factors as are known in the art.

In an alternate embodiment, the entire DFA or part of it, is used to evaluate different selections of base classes by directly compiling the DFAs including applying the base class mapping based on these base-classes-under-test in order to determine the optimum base class set resulting in the smallest data structure.

In yet another embodiment, base classes are selected which contain values (e.g., consecutive values or with a given stride, having a certain alignment) that allow the BFSM compiler to select a hash-function that will result in a more compact hash structure.

Technical effects and benefits include increased performance for pattern matching processing by using compact rule sets. An additional benefit is the ability to sort rules to increase efficiency by selecting rules that are easier to evaluate before rules of higher complexity. Yet another benefit is the ability map a large number of rules into a smaller amount of memory using bit level rule mapping.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be constructed to maintain the proper protection for the invention first described.

What is claimed is:

1. A state machine, comprising:
a hardware rule selector, the rule selector being configured to receive input data, and one or more transition rules, the one or more transition rules comprising a next state;
a hardware character classifier communicatively coupled to the rule selector, the character classifier comprising a plurality of base classes and being configured to receive the input data and to send one or more of the plurality of base classes to the rule selector in response to receiving the input data; and
the rule selector being further configured to select one of the one or more transition rules in response to determining that the input data and one of the plurality of base classes correspond to the transition rule, and to set a current state of the state machine to the next state of the selected one of the one or more transition rules.

2. The state machine of claim 1, wherein the input data comprises an input data bit vector, and the plurality of base classes comprise one or more base class bit vectors.

3. The state machine of claim 2, wherein the rule selector is configured to select the transition rule using one or more bitwise operations against the input data bit vector, and the one or more base class bit vectors.

4. The state machine of claim 3, wherein the rule selector comprises one or more AND gates, and at least one OR gate, and wherein the rule selector is configured to perform the one or more bitwise operations against the input data bit vector, and one or more of the one or more base class bit vectors using the one or more AND gates, and at least one OR gate.

5. The state machine of claim 3, wherein the rule selector is configured to use a rule select bit in the bitwise operation to select one of the one or more base class bit vectors.

6. A system for base class mapping, comprising:
a hardware pattern compiler module, the pattern compiler module for compiling a deterministic finite automaton (DFA), the compiling comprising:
receiving a plurality of base class vectors and a plurality of negated base class vectors;
receiving one or more unmapped transition rules in an unmapped list; and
processing each of the one or more unmapped transition rules, the processing comprising:
selecting and removing one unmapped transition rule from the unmapped list;
creating an input vector from the selected transition rule;
generating one or more mapped rules from the input vector; and
storing the one or more mapped rules in a mapped list.

7. The system of claim 6, wherein the unmapped list is sorted according to a decreasing class size, and the unmapped transition rules are processed according to the sorted order.

8. The system of claim 6, wherein the generating comprises mapping the input vector to a regular rule.

9. The system of claim 6, wherein the generating comprises mapping the input vector to a base class combination.

10. The system of claim 9, wherein when the input vector comprises characters that are not in the base class combination, the processing further comprises:
creating a new unmapped transition rule;
adding the characters to the new unmapped transition rule; and
placing the new unmapped transition rule in the unmapped list.

11. The system of claim 10 wherein the unmapped list is sorted according to a decreasing class size in response to the placing.

12. The system of claim 9, wherein when the base class combination comprises characters that are not in the input vector, the processing further comprises:
incrementing a priority of each transition rule in the unmapped list and the mapped list;
creating a new unmapped transition rule;
adding the characters to the new unmapped transition rule;
setting a priority of the new unmapped transition rule; and
placing the new unmapped transition rule in the unmapped list.

13. The system of claim 12 wherein the unmapped list is sorted according to a decreasing class size in response to the placing.

14. The system of claim 9, wherein when the base class combination is equal to the input vector, the processing further comprises:
creating a new mapped transition rule;
adding the base class combination to the new mapped transition rule; and
placing the new mapped transition rule in the mapped list.

15. A computer implemented method for base class mapping, comprising:
receiving, on a computer, a plurality of base class vectors and a plurality of negated base class vectors;
receiving, on the computer, one or more unmapped transition rules in an unmapped list; and
processing, on the computer, each of the one or more unmapped transition rules, the processing comprising:
selecting and removing one unmapped transition rule from the unmapped list;
creating an input vector from the selected transition rule;
generating one or more mapped rules from the input vector; and
storing the one or more mapped rules in a mapped list.

16. The method of claim 15, wherein the unmapped list is sorted according to a decreasing class size, and the unmapped transition rules are processed according to the sorted order.

17. The method of claim 15, wherein the generating comprises mapping the input vector to a regular rule.

18. The method of claim 15, wherein the generating comprises mapping the input vector to a base class combination.

19. The method of claim 18, wherein when the input vector comprises characters that are not in the base class combination, the processing further comprises:
creating a new unmapped transition rule;
adding the characters to the new unmapped transition rule; and
placing the new unmapped transition rule in the unmapped list.

20. The method of claim 19 wherein the unmapped list is sorted according to a decreasing class size in response to the placing.

21. The method of claim 18, wherein when the base class combination comprises characters that are not in the input vector, the processing further comprises:
incrementing a priority of each transition rule in the unmapped list and the mapped list;
creating a new unmapped transition rule;
adding the characters to the new unmapped transition rule;
setting a priority of the new unmapped transition rule; and
placing the new unmapped transition rule in the unmapped list.

22. The method of claim 21 wherein the unmapped list is sorted according to a decreasing class size in response to the placing.

23. The method of claim 18, wherein when the base class combination is equal to the input vector, the processing further comprises:
creating a new mapped transition rule;
adding the base class combination to the new mapped transition rule; and
placing the new mapped transition rule in the mapped list.
